(19) United States
(12) Patent Application Publication
(10) Pub. No.: US 2012/0085787 A1
(43) Pub. Date: Apr. 12, 2012

(54) Pinch tube with internal piston dispensing extractor and snap ring/closure cap fittings

(76) Inventor: Marc Mamiye, Old Bridge, NJ (US)

(21) Appl. No.: 12/924,979

(22) Filed: Oct. 12, 2010

(51) Int. Cl. G01F 11/00; B65D 35/00

(52) U.S. Cl. 222/386; 222/107

(57) ABSTRACT

A viscous liquid dispensing device for a cylindrical tubular reservoir includes an internal piston wedge, a first fitting encircling an outside wall of the reservoir, and a second fitting joined with the first fitting, with the second fitting having a flip-top cap enclosing an opening of dimension and size to receive a head of the piston wedge as it is removed forwardly along the reservoir from a closed end by a pinching action of the thumb and index finger upon a tail of the piston wedge.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to disposable viscous liquid dispensing devices and, more particularly, a new and improved device for extracting such viscous liquids as flowable candy or confectionery products, medicinal preparations and toothpaste from tubular reservoir containers.

2. Description of the Related Art

As is well known, flexible plastic tubes have been used for many years as a reservoir container for a wide variety of viscous liquid products. As is also well known, such containers have proven popular primarily because of their convenience and cost as compared with other types of packaging possibilities. While improvements have been made over the years to these containers, for the most part, the tubes employed have remained substantially the same. One concern that subsists, however, is the amount of product/content that remains at the time of discarding the container—oftentimes as much as twenty percent of its initial filling. A second concern is the recycling issues associated with the premature container discarding, which affects the environment.

Several attempts have been made to improve the problems associated with the wasted product/content remaining in the tube. Most focus on “add-on” type devices—in the form of “tube squeezers” or “keys” to assist in the removal of the product/content. Such “add-ons” obviously increase manufacturing costs.

Common to these “tube squeezers” or “keys” are their attachment and utilization externally, from outside the tube. Essentially, the idea is to flatten the tube by sliding or rolling up the “add-on” as far toward the nozzle opening of the tube as it can go. Unfortunately, however, such “add-ons” stop working before reaching the shoulder of the nozzle because the shape and rigidness of the tube's shoulder limits movement beyond the shoulder to the nozzle opening and, thus, the ability of the tube to completely flatten. A good percentage of the product/content then remains inside the tube at its discarding.

The suggested dome-shaped tube squeezer type of “add-on” will be understood to be pushed along the length of the tube from its sealed end towards the semi-rigid shoulder and nozzle. Typically, the maximum sliding range is only some 80-85% the length of the tube, besides being unable to flatten the spacing along its side edges. The alternatively utilized key-shaped squeezer “add-on” inserted over the sealed end of the tube and wound and rolled in an upwards fashion suffers the same problems as it approaches the rigid shoulder adjacent the nozzle's opening. Additionally, it exhibits the further disadvantages of frequently being lost, being unwieldy in use, and being unsightly in appearance due to the key's outward projection from the tube itself. The premature discarding of the tube container thus continues, and contributes to a greater accumulation of non-reusable trash.

### OBJECTS OF THE INVENTION

It is an object of the present invention, therefore, to provide a new and improved manner of extracting viscous liquids from their reservoir container tube enclosures.

It is another object of the invention to provide a viscous liquid dispensing container which allows for the extraction of its product/content leaving as little residue as possible.

It is an object of the present invention, also, to provide a viscous liquid dispensing device whose appearance in no ways detracts from that of a plastic tube reservoir in which the viscous liquid is contained.

### SUMMARY OF THE INVENTION

The present invention offers a new tube system employing an internal device to extract the product and reduce the amount of its contents otherwise left inside of the tube, as contrasted with the external “add-ons”, which define the prior art. As will be seen, an internal piston here operates as a “wedge”, sliding up all the way from the sealed end of the tube beyond its nozzle's shoulder and to the nozzle opening. With the piston conforming in shape and dimension to the inside wall of the tube, with the piston being of a rigid fabrication and with the wall exhibiting an elasticity consistent with its being of a soft plastic manufacture, the wall of the tube offers a resiliency to stretch over the rigid piston. Once the piston is inserted into the tube in this manner, not only will the wall of the tube shrink back, but all areas of the piston will continue to press against the tube's inner wall. The tube's product content can then go nowheres, but forward, out through the nozzle's opening. And, with a viscous liquid product content, since it will act as a self lubricant for the piston, no additional lubrication would be required for the sliding movement to dispense or extract the flowable candy, medicinal preparation, toothpaste, etc.

In a first aspect of the invention to be described, the piston wedge will be seen to be utilized with the standard type of tubular reservoir container commonly employed. In a second aspect of the invention, the piston wedge will be seen to be utilized in a new and different tubular reservoir container construction.

### BRIEF DESCRIPTION OF THE DRAWINGS

These and other features of the present invention will be more clearly understood from a consideration of the following description, taken in connection with the accompanying drawings, in which:

FIGS. 1a-1d are views helpful in an understanding of the piston-wedge constructed in accordance with the teachings of the invention;

FIGS. 2a-2d are views helpful in an understanding of the manner of inserting the piston-wedge of FIGS. 1a-1d into a cylindrical tubular reservoir-container system of the type used in conventional viscous liquid dispensing arrangements, in accordance with a first aspect of the invention;

FIGS. 3a-3f are illustrative views of system components helpful in an understanding of the piston extracting concept in accordance with the second aspect of the invention; and

FIGS. 4a-4f are assembly views helpful in an understanding of the interrelationship between the component parts of FIG. 3a-3f, the piston-wedge of FIGS. 1a-1d and the optional airway hole cover-up labelling of FIGS. 2a and 2b in providing a leak-resistant dispensing system according to the second aspect of the invention.

### DETAILED DESCRIPTION OF THE INVENTION

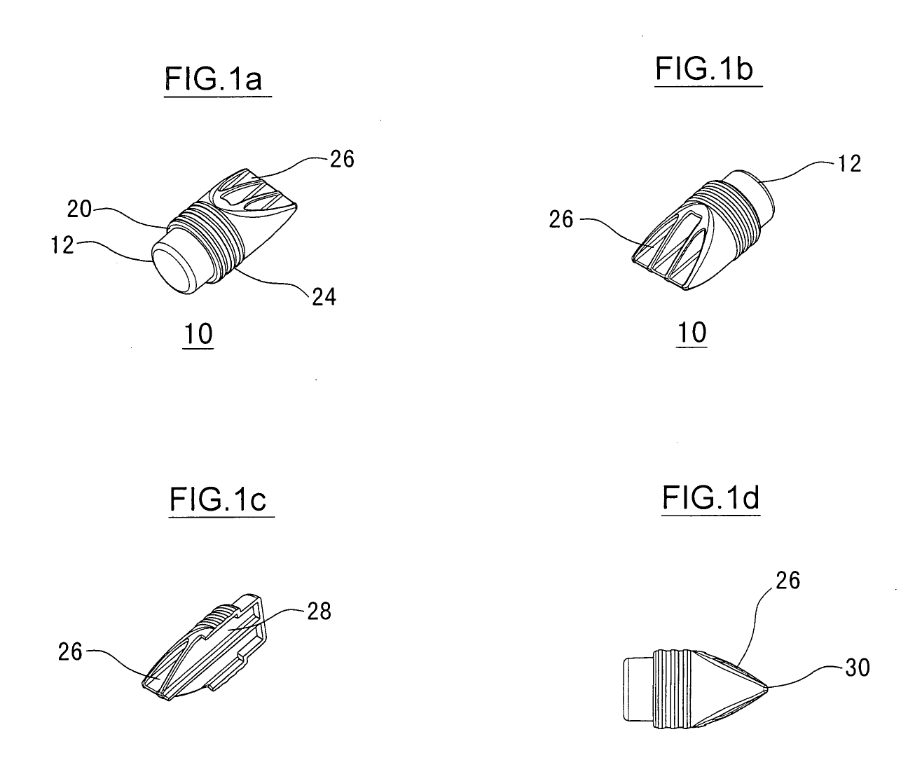

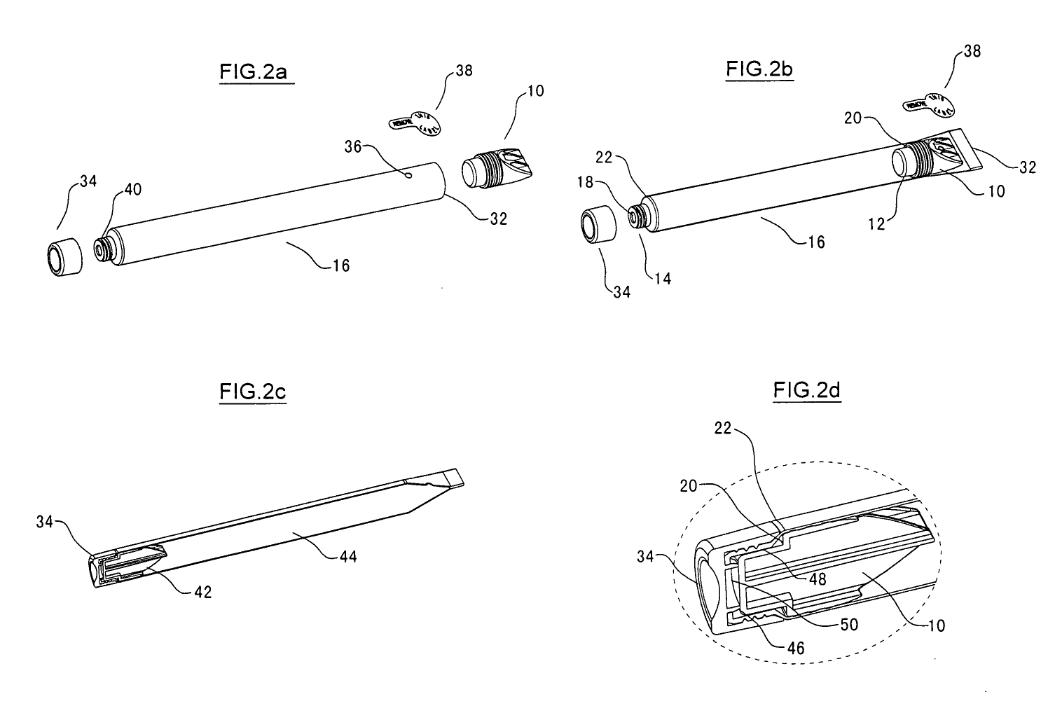

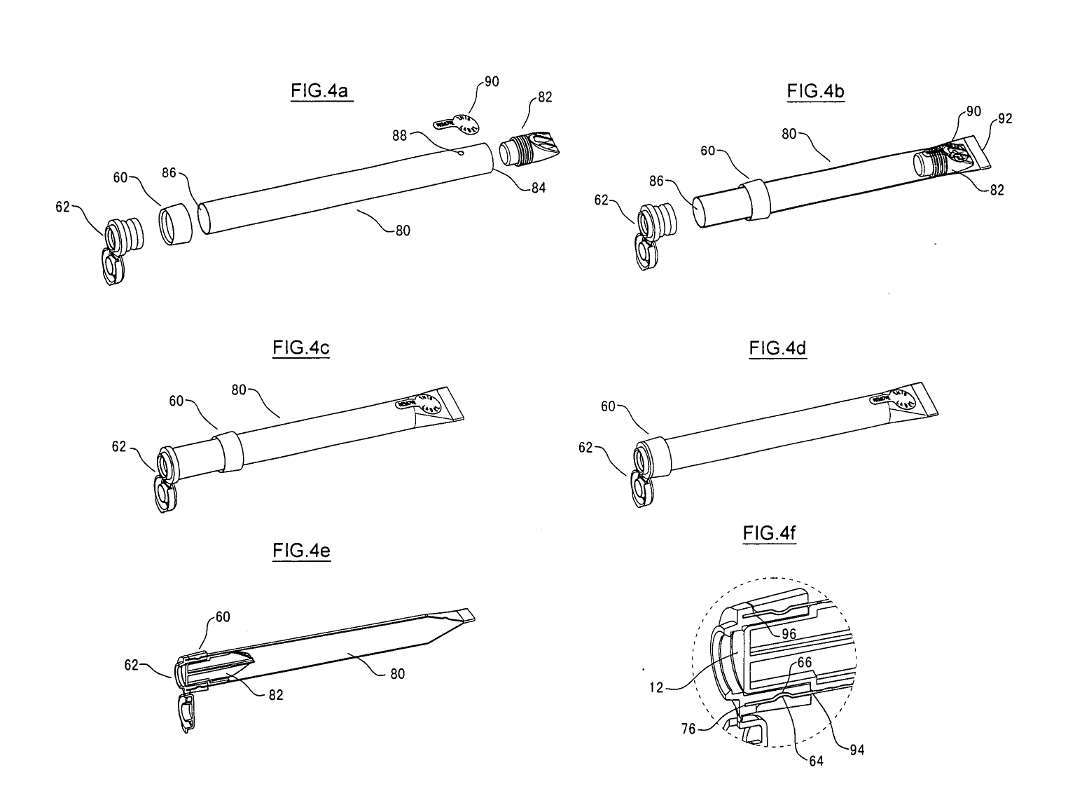

The piston-wedge (or simply “piston”), constructed in accordance with the conventional cylindrical tube of FIGS. 2a-2d and with the alternative cylindrical tube configuration of FIGS. 4a-4f, is shown by reference numeral 10 in FIG. 1a-1d. A head of the piston is shown at 12, and its size and shape conform with the diameter of the tube's nozzle orifice opening (shown at 18 in FIG. 2b). Such correspondency will allow all or most of the product/content of the tube 16 to be pushed by the piston out from the tube's nozzle 14 once inserted into the tube and moved forwardly along. A shoulder of the piston 10 is shown at 20 in FIG. 1a, which bears against and is stopped by the semi-rigid shoulder of the tube shown at 22 in FIG. 2b. Reference numeral 24 in FIG. 1a identifies a series of rings (3 in FIG. 1a) slightly larger in diameter than the inside diameter of the tube 16 of FIGS. 2a-2d, typically fabricated of a soft plastic. The rings 24 are what allows the product content in the tube to only move forwardly and out the tube 16 through the nozzle orifice opening 18, and insures that virtually none of the product is left behind when pushing the piston forward by a pinching action. The first ring (the one closest to the head 12) pushes the product out of the orifice 18, possibly, however, leaving a small residual amount. The second ring serves as a back-up, and collects and pushes forward any residue that may have been left behind the first ring. The third ring (furthest from the head 12) operates the same way as the second ring to push forward any remaining residue. This dispenses or extracts all the product content confronted by the piston 10 in moving along internally of the tube. By having the rings 24 of larger diameter than the inside diameter of the tube, essentially no residue will collect at the inner wall of the tube.

Reference numeral 26 in FIG. 1a identifies a plurality of tracks or channels (3 in number) which allows the piston 10 to have a reduced surface and contact area. Having these tracks or channels allows a user to pinch the piston its forward movement with less force or drag than would otherwise be the case. As the tracks or channels 26 reduce the amount of contact area with the inner wall of the tube 16, they additionally allow the piston 10 to be hollow, as shown at 28 in the sectional view of FIG. 1c. The result is a saving in plastic in the manufacture of the piston 10, and in reducing its overall weight.

(In these respects, it will be understood that FIG. 1a is a perspective top and front view of the piston 10, FIG. 1b is a perspective front view of the piston, and FIG. 1c is a perspective front sectional view of the piston.)

Consistent with this, FIG. 1d represents a side view of the piston 10. By having its tail end 30 “dome-shaped”, the piston is allowed to move forwardly along the tube 16 towards the nozzle 14 in an easy manner. Such “dome-shape” also conforms to the bottom end 32 of the tube 16 after it is sealed (FIG. 2b). This configuration allows the piston 10 to fit at insertion as far down the tube as possible, with the shape of the tail end 30 additionally serving to conform to a user's thumb and index finger for a pinching motion to follow. As such, a pinching by the thumb and index finger allows the piston 10 to move along the tube 16 in this “pinch tube system” of utilization. (Reference numeral 34 in FIG. 2a identifies the standard screw on cap for the reservoir container tube 16.)

In a preferred manner of this construction, the material of choice for the piston 10 is High Density Polyethylene (HDPE), whose properties allow the piston to be rigid. While attractive for its smooth non-stick type surface so as to allow the piston to glide easily along the tube length, other resins might alternatively be employed—e.g. Polyethylene (PE), Low Density Polyethylene (LDPE), Linear Low Density Polyethylene (LLDPE), Polypropylene (PP), and Nylon. However, use of such materials will be appreciated to possibly increase the pinch force for movement slightly, but would still function in a satisfactory manner. Therefore, having a piston of a rigidity, yet of a material manufacture of reduced friction, is preferable for use in order to be glided forwardly easily and smoothly, with little grab. (As will also be appreciated, such piston would not generally require any added lubrication to function in a gliding manner with a viscous liquid product content, as the product/content in the tube itself would act as a self-lubricant when contacting the first of the rings 24, i.e., the one closest to the head 12.)

The manner of utilizing the piston wedge of FIGS. 1a-1d with a commonly used type of soft plastic reservoir/container tube can best be understood from FIGS. 2a-2d. In the exploded view of FIG. 2a, reference numeral 10 identifies the piston and reference numeral 16 identifies a soft plastic tube container—preferably made from Polyethylene (PE). Reference numeral 36 identifies an optional airway hole to permit airflow to the tube 16 after the piston 10 is pinched upwards and forwardly. Without such airway hole, the tube 16 behind the piston 10 would tend to flatten during the pinching in dispensing the product/content and somewhat hinder the gliding movement. A label 38 is shown to cover-up the airway hole 36 intended to keep the system sealed off during transportation and storage, but removed when the dispensing or extraction is to take place.

In FIG. 2b, the piston 10 is inserted and pushed in from the bottom opening of the tube 32. The piston head 12 (FIG. 1a) is selected of the same diameter as the nozzle opening 18 and the shoulder of the piston 20 conforms in size and shape to the semi-rigid shoulder of the nozzle 22. The bottom end of the tube 32 is sealed closed after the piston 10 is inserted in the tube 16. The cap 34 couples with the screw threads 40 of the nozzle 14.

In the sectional and magnified view of the pinch-piston, tube system of FIG. 2c, the piston 10 is pushed forward as far as it will go, as at 42. As more clearly shown in the magnified sectional view of the assembly in FIG. 2d, the shoulder of the piston 20 bears up against the shoulder of the tube 22, and the head of the piston 12 extends through the nozzle-orifice opening 18 at 46. Reference numeral 44 identifies a view of the sectioned tube 16, and the screw-on cap 34 assembles them to the nozzle 14 at 48. The head of the piston 12 meets up with an inner sealing ring 50 of the cap 34, leaving the only possibility of remaining product/content to be in and around the cavity of the sealing ring.

As shown in FIGS. 2c and 2d, the piston 10 reaches all the way to the nozzle opening 18, leaving no space in the tube for product/content to remain.

Product/content may be added to the tube system of this aspect of the invention in one of two ways: a) the piston 10 is pushed into the open bottom end of the tube 32, the bottom end is sealed, the viscous liquid product is added to the tube 16 from the nozzle opening 18 and the cap 34 is screwed onto the nozzle 14; or b) the cap 34 is screwed onto the nozzle 14, the viscous liquid product is filled from the open bottom end of the tube 32, the piston 10 is pushed into the tube 16 through the bottom end 32, and the bottom end 32 is then sealed. In either event, the shape of the sealed bottom end of the tube and of the tail end of the piston 30 conform to one another. Once the bottom end 32 is sealed and the cap 34 is in place, the piston 10 then becomes a part of the tube, and cannot be removed unless the user intentionally cuts open the tube with a sharp object such as a knife or scissor. In this manner a pinched-piston, tube system is provided.

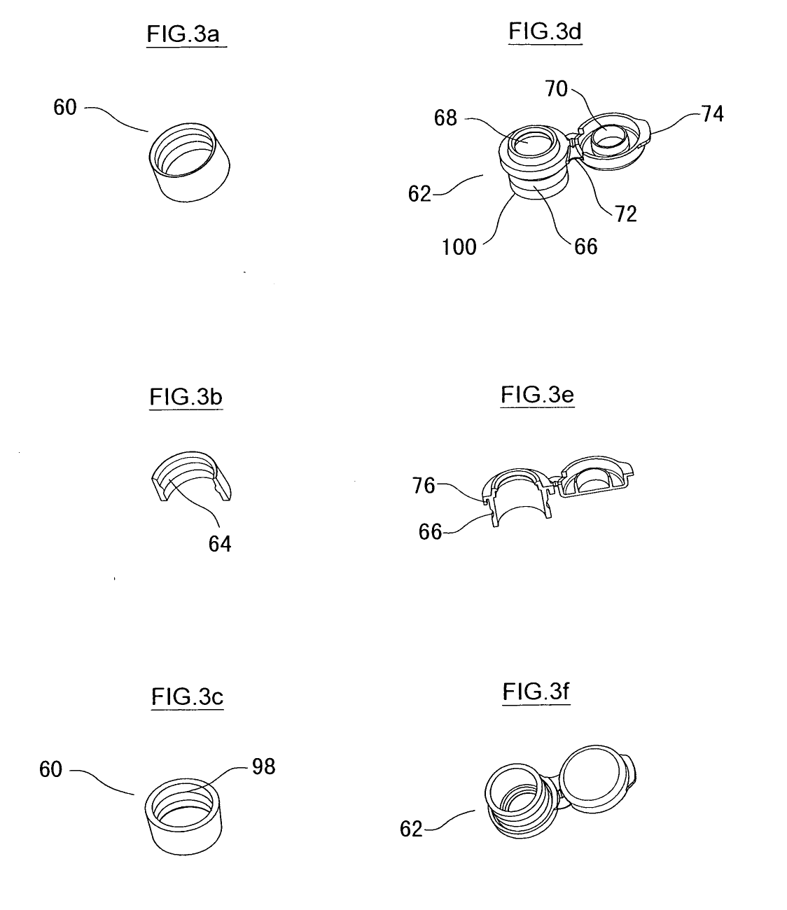

To add to the dispensing-extracting advantages offered through the use of the internal piston wedge of FIGS. 1a-1d, a second aspect of the present invention employs a new and different reservoir/container dispensing tube. Component parts utilized in the construction of this tube are shown in FIGS. 3a-3f. FIGS. 3a, 3b and 3c respectively show a perspective top view, a sectioned top view and a perspective bottom view of a snap ring fitting 60. FIGS. 3d, 3e and 3f, correspondingly, show a perspective top view, a sectioned top view and a perspective bottom view of a flip cap closure fitting 62. A fastening ring of the snap ring 60 is shown at 64, is convex, and conforms with a fastening ring 66 of the flip cap closure 62 which is concave. An opening of the flip cap closure 62 is shown at 68, and receives a cap closure sealing ring 70, which snaps into it. A living hinge 72 joins the top of the flip cap closure (i.e, the right portion of FIG. 3d) with the base of the flip cap closure 62 (i.e., the left portion of FIG. 3d) while a pull tab 74 serves to open the flip cap closure 62 after the sealing ring 70 snaps into the opening 68. Reference numeral 76 in the sectioned top view of FIG. 3e identifies a closure channel to position the tube of this aspect of the invention to accept the final assembly of the flip cap closure 62, the tube, and the snap ring 60 together. Such assembly is illustrated more specifically with reference to the various views of FIGS. 4a-4f.

Referring to FIG. 4a, the piston 10 of FIGS. 1a-1d is shown at 82, a shoulder-less, nozzle-less, different type of cylindrical tube 80 is shown as having an open bottom end 84, an open top end 86, an optional airway hole 88 and an optional airway hole cover-up label 90 (similar to the airway hole 36, and cover-up label 38 of FIGS. 2a and 2b). FIG. 4a also shows the snap ring 60 of FIGS. 3a-3c and the flip cap closure 62 of FIGS. 3d-3f. Once the tube 80 is filled with its viscous liquid product content, either through the open bottom end 84 or the open top end 86, the piston 82 is inserted through the open bottom end 84 and the open bottom end is then sealed.

FIG. 4b illustrates the piston 82 inserted inside the tube 80, with the snap ring 60 being placed externally over the tube 80 and moved approximately one third of the way down from its open top end 86 towards its now sealed bottom end 84. The optional airway hole label 90 is applied to cover the optional airway hole 88.

In FIG. 4c, the flip top closure 62 is pushed into the open top end 86 of the tube 80—followed by the snap ring 60 being moved up from its one-third position to fasten together with the flip top closure 62 as in FIG. 4d. As with the aspect of the invention shown in FIGS. 1a-1d and 2a-2d, the tube 80 is fabricated of a soft plastic (preferably Polyethylene) while the piston 80 is fabricated of a smooth, non-sticking, rigid plastic (preferably High Density Polyethylene).

FIGS. 4e and 4f illustrate a sectional view of the assembly with the piston 82, the tube 80, the snap ring 60 and the flip top closure 62 in position after the piston 82 is pinched up from the sealed bottom end of the tube. With this construction, the head of the piston 12 reaches all the way to the top of the flip cap closure 62, which together with the slightly larger diameter rings of the piston, allows for only a fractional amount of product/content to remain in the closed-off tube.

FIG. 4f illustrates a magnified sectional view of this, and shows at 94 the top of the tube's wall sandwiched between the snap ring's fastening ring 64 and the flip top closure's fastening ring 66 in forming a tight fit with the tube 80 in acting as a sealing gasket between the snap ring 60 and the flip cap closure 62. Additionally, at the area of the two fastening rings 64 and 66, the wall of the tube 80 conforms to the contour of the fastening rings 64 and 66 so as not to allow the possibility of leakage. This also serves to strengthen the bond between the parts, making them virtually undetachable. A leak resistant and non-removable assembly results, along with the further advantage of eliminating any use of adhesives, welding, heat sealing or other means to attach the components together as exist with the standard, conventional type of tubular reservoir container construction. A savings of manufacturing cost and time thus results as well.

FIG. 4f, furthermore, illustrates the end of the tube 96 fitting into the channel 98 of the snap ring fitting 60 (FIG. 3c), the snap ring 60 assembled with the tube 80 and the flip cap closure fitting 62, and the pushing and fitting together of the top end of the tube 86 with the channel of the cap closure 76 (FIG. 3e). A new tube and closure system thus results, with the internal dispensing, extracting piston wedge glided forwardly by the thumb and index finger pinching action to drive substantially the entire viscous liquid product content out the tube.

As with the embodiment of the first aspect of the invention described with respect to FIGS. 2a-2d, the viscous liquid product content could be added to the tube through an open bottom end before the piston is inserted and the open bottom end then sealed, or through an open top end after the piston is inserted and the bottom end sealed. The piston head 12 is of a length to extend through the closure cap opening 68 once its shoulder 20 contacts the bottom edge of the cap, at 100.

While there have been described what are considered to be preferred embodiments of the present invention, it will be readily appreciated by that modifications can be made by those skilled in the art without departing from the scope of the teachings herein. For example, while the preferred construction of the piston drive of the invention is shown as being cylindrical in shape, the piston can be fabricated in other shapes as well—such as oblong, oval, triangular, square—whatever is needed to conform to the internal sectional arrangement of the tube employed, and to the tube opening. Additionally, other types of internal closure fitting, snap ring combinations may be employed, again depending upon the cross-sectional configuration of the tube utilized with the internal drive system and upon the opening configuration. And, likewise, the convex-concave relationship between the snap-ring fitting and flip cap closure fitting rings 64 and 66 can be reversed, and the fastening between them still be the same. For at least such reasons, therefore,—and whether one considers the pinch tube internal piston construction of FIGS. 1a-1d and FIGS. 2a-2d, or the sandwich-type tube, snap ring/closure cap arrangement of FIGS. 3a-3f and 4a-4f—resort should be had to the claims appended hereto for a true understanding of the scope of the invention.

I claim:

1. A viscous liquid dispensing device comprising:
a cylindrical reservoir adapted to contain a viscous liquid having a sealed closure at a first end and an opposite, second end;
a piston wedge within the reservoir adjacent said first end having a body and a head of predetermined dimension and size;
a first fitting encircling an outside wall of said reservoir; and
a second fitting, joined with said first fitting, extending into said opposite, second end of said reservoir;
with said second fitting having a flip-top cap enclosing an opening at said second end of dimension and size substantially conforming to the head of said piston wedge.

2. The viscous liquid dispensing device of claim 1, with said first fitting internally having one of a concave and convex encircling ring, and with said second fitting having a cylindrical body with one of an externally encircling concave and convex ring fastened with said encircling ring of said first fitting.

3. The viscous liquid dispensing device of claim 2 wherein said first fitting includes a convex encircling ring and wherein said second fitting includes a concave encircling ring.

4. The viscous liquid dispensing device of claim 2 wherein said second fitting includes a base extending into said opposite, second end of said reservoir and a living hinge joining said base to said flip-top cap.

5. The viscous liquid dispensing device of claim 2 wherein said first fitting is movable along the length of said cylindrical reservoir in joining with said second fitting.

6. The viscous liquid dispensing device of claim 5 wherein the piston wedge is of a rigid plastic fabrication and wherein the cylindrical reservoir is of a soft plastic fabrication.

7. The viscous liquid dispensing device of claim 6 wherein the body of said piston wedge includes at least one encircling ring of a shape conforming to the internal cross-section of said cylindrical reservoir, and of a diameter slightly larger thereof.

8. The viscous liquid dispensing device of claim 7, including 3 spaced-apart rings encircling the body of said piston wedge, each of which is of a shape conforming to the internal cross-section of said cylindrical reservoir, and each of equal, slightly larger diameter then that of said reservoir.

9. The viscous liquid dispensing device of claim 8 wherein the piston wedge also includes a tail conforming in shape to the closure at said first end of said cylindrical reservoir.

10. The viscous liquid dispensing device of claim 9 wherein the tail of said piston wedge includes at least one channel of reduced surface and contact area extending forwardly of said tail.

11. The viscous liquid dispensing device of claim 10 wherein said piston wedge includes 3 spaced-apart channels extending forwardly of said tail.

12. The viscous liquid dispensing device of claim 11 wherein the piston wedge also includes a shoulder and wherein the head of the piston wedge is of a length to extend forwardly from said shoulder through said enclosed flip-top cap opening to bear said shoulder against a bottom ring of said first fitting.

13. The viscous liquid dispensing device of claim 12, also including an airway hole on a wall surface of said cylindrical reservoir.

14. The viscous liquid dispensing device of claim 13, also including a cover-up label for opening and closing said airway hole.

15. The viscous liquid dispensing device of claim 6 wherein said piston wedge is fabricated of High Density Polyethylene and wherein said cylindrical reservoir is constructed of Polyethylene.

16. The viscous liquid dispensing device of claim 15, also including one of a flowable candy or confectionery product, medicinal preparation or toothpaste within the cylindrical reservoir between the head of the piston wedge and the opening enclosed by said flip-top cap.
